(19) United States
(12) Patent Application Publication
(10) Pub. No.: US 2012/0321748 A1
(43) Pub. Date: Dec. 20, 2012

(54) Single Cup Beverage Ingredient Filter Basket and Method of Using Same

(76) Inventors: Jay D. Otto, (US); R. William Graham, Dayton, OH (US)

(21) Appl. No.: 13/480,788

(22) Filed: May 25, 2012

Related U.S. Application Data
(63) Continuation-in-part of application No. 13/161,785, filed on Jun. 16, 2011.

(51) Int. Cl. A47J 31/08; A23F 5/26; B65B 29/02

(52) U.S. Cl. 426/80; 426/433; 99/302 R

(57) ABSTRACT

A coffee filter basket includes a filter retainer having an outer shell with an upper end having open top and a bottom including an opening, an insert having an upper collar of a less than the diameter than the upper end of the retainer to fit therein and having a lower extension which when a filter is disposed within the retainer and the insert is disposed within the filter, the insert press-fits within the retainer to retain the filter adjacent the retainer shell, and a removable top having an outer perimeter lip portion of at least that of the diameter of the upper end of the retainer and a lower collar portion of a diameter less than the diameter of the upper collar and configured to press-fit therein to secure the insert in the retainer, wherein the removable top has an opening. A method of use is provided.

This is a continuation in part which claims the benefit of U.S. patent application filed Jun. 16, 2011 bearing Ser. No 13/161,785.

### BACKGROUND OF THE INVENTION

1. Field of Invention

This invention relates to filter cups adapted for use in coffee makers of the high pressure high heat single cup type coffee makers, such as, Keurig, Cuisinart, Tassimo and Mr. Coffee single cup types, and to a method and apparatus for using the same.

2. Prior Art

Drip-type electric brewing machines have been used as an efficient means for making coffee. The coffee brewing machine typically has a cold water reservoir, an electric resistance heating element for heating the water, and a reusable plastic brew basket for holding ground coffee in a paper coffee filter. To make coffee, cold water is poured into the water reservoir and ground coffee is placed in a coffee filter, which is in turn placed in the brew basket. The cold water is heated by the electric heating element, and the heated water then saturates the ground coffee. The brewed coffee then drips out into a pot below the brew basket. The paper filter and used coffee grounds are taken out of the plastic brew basket and discarded. Then, the brew basket and coffee pot are cleaned for re-use.

Recently, there has been a trend to provide a single use disposable brew pod for a single cup electric coffee brewing machine that is designed for brewing a single cup of coffee directly into a coffee cup. This was designed with the thought of providing a quick and convenient cup of coffee on demand.

A trendy brand of pod has been introduced by Keurig, Inc. in which a single use coffee pod works within its beverage pod receiver. This is seen in U.S. Pat. No. 7,513,192. Other such coffee makers of using single cup pods include Cuisinart, Tassimo and Mr. Coffee types typically which also employ filter cups which are part of a sealed pod which include ground coffee therein. The pods typically have a polymer filter which is adhered to the wall of the plastic pod. The filter in such pods is plastic to withstand the high pressure and heat which is posed by a single stream of intense water pressure, as opposed to conventional drip coffee makers. These pods pose a significant environmental issue and are very costly and a health concern.

In addition to these pods, other solutions have been tried. For example, one solution uses a technique of providing a metal filter basket which is removably enclosed in a pod having an opening on a top and bottom. This device must be washed out which is difficult to do as the area within such pod is less than a couple of inches and it is difficult to access for purposes of cleaning. Moreover, this takes away from the convenience of single cup brewing.

Another device attempted to use a non metal disposable filter which has a bottom cup and an upper lid and hingedly adhered at an edge to the cup and which can be filled with ground coffee and then enclosed in a snap fit manner within a second plastic cup having a small opening therein and a lid connected to the second cup, the lid having a hole therein to receive the conduit of the coffee maker. This too has flaws. The filter is expensive to make and is awkward to maintain open for filling the bottom cup with coffee.

Prior alternatives result in an inferior brew. This is due to the fact that the stream of high pressure causes a channel to be formed centrally through the pod and grounds as this is the path of least resistance. Accordingly, a weak cup of coffee is provided.

Despite these shortcomings, the consumer has found the single cup coffee brewing a desirable method for brewing coffee. There is a need for a more desirable high pressure single cup filter which overcomes the deficiencies in the art. The instant invention provides a solution which overcomes these prior deficiencies.

### SUMMARY OF THE INVENTION

It is an object of the invention to provide new and improved high pressure filter cup adapted for use in single cup type coffee makers.

It is a further object of the invention to provide a paper filter cup from a single unitary, unseamed sheet of filter paper.

It is another object to provide a method of using the same for brewing beverages.

It is a further object to minimize waste in brewing single cup coffee.

It is another object to improve the efficiency of a single use coffee machine.

It is a more specific object of the invention to provide a single use filter in a reusable brew basket.

Still another object of the invention is to provide a single use filter, a reusable brew basket for a high a pressure high heat electric coffee brewing machine that is designed for brewing a single cup of coffee directly into a coffee cup.

Further objects of the invention are to avoid the disadvantages of the prior art and to obtain such other advantages as will appear as the description proceeds.

An aspect of the instant invention is directed to a seamless filter for use in a reusable beverage filter basket of a single cup type. The filter has a substantially planar base portion having a generally rounded periphery, the base portion having an inside surface for receipt of beverage forming ingredient, and a resilient, substantially annular sidewall portion which extends upwardly and radially outwardly from the rounded periphery of the planar base portion, the annular sidewall portion having an inner surface for receipt of beverage forming ingredient and an outside surface for contacting the retainer and wherein the annular sidewall includes a plurality of ridges extending radially outwardly and valleys extending radially inwardly, the plurality of ridges and valleys cooperating when press-fit between the insert and retainer to enhance the flowability of liquid through the filter. The filter is of a sufficient strength such that the sidewall when press-fit between a retaining cup and insert of the instant invention sufficiently aids in retention of the filter between the retainer and the insert for permitting a beverage forming ingredient to be held within the filter yet not so tight between the insert and retainer as to substantially restrict fluid flow through the sides of the filter.

Another aspect of the invention includes a reusable beverage filter basket for a which includes:

a filter retainer having an upper end with open top and a bottom end including an opening therein;

an insert having an upper collar of a less than the diameter of the upper end of the retainer to fit therein and having a lower end or extension which when a filter is disposed between the retainer and the insert, the insert is dimensionally proportioned to press-fit the filter within the retainer to retain the filter therebetween and for permitting a beverage forming ingredient to be held therein yet not so tight between the insert and retainer as to substantially restrict fluid flow through sides of the filter and cause undue pressure on a bottom of the filter; and

a top having an outer perimeter lip portion of a diameter and configuration positionable to form a closure about the upper end of the retainer when disposed thereagainst. Preferably, the retainer is in a form of a cup and the top is removable and has a lower collar portion of a diameter less than the diameter of the upper collar of the insert and configured to press-fit the and to secure the insert and filter within the retainer. The top has an opening therethrough.

In this way, a single-use filter can be employed with coffee or other beverage ingredient therein and discarded after its use. The upper collar also can include a peripheral lip portion of a diameter at least that of the upper end of the retainer, and preferably larger, to aid in removal of the insert. Further, the lower collar portion of the top and the collar of the insert can be formed with a complementary detent mechanism to snap fit together and secure the two together for use and removal. An edge of either of the peripheral lip of the insert or the lip portion of the top can be recessed or extended (in the form of a tab) to aid in separation of the two once connected.

A method of brewing a single cup of coffee comprises the steps of: providing an electric coffee brewing machine; providing a reusable brew basket having a filter retainer having upper end having open top and a bottom including an opening therein, an insert having an upper collar of a less than the diameter than the upper end of the retainer to fit therein and having a lower extension or end which when a filter is disposed between the retainer and the insert, the insert press-fits the filter within the retainer to retain the filter therebetween yet not so tight as to substantially restrict fluid flow through sides of the filter and thus cause undue pressure on a bottom of the filter, and a top having an outer perimeter lip portion of at least that of the diameter of the upper end of the retainer and a lower collar portion of a diameter less than the diameter of the upper collar and configured to secure the insert. The filter is held not so tight between the insert and retainer as to substantially restrict fluid flow through sides of the filter. As so assembled with the insert and filter within the retainer, a beverage forming ingredient is poured therein. The method inserts a single-use coffee filter into the retainer, placing the insert into the filter in a manner to cause the same to be press-fit between the retainer and insert, pouring coffee into the filter, connecting the top onto the retainer such that the lower collar portion press-fits to the insert, inserting the brew basket into the electric coffee brewing machine; brewing a single cup of coffee with the electric coffee brewing machine. The method further includes disassembling the basket, removing the filter with coffee therein and discarding the same while retaining the basket for reuse.

Advantageously, the filter is at least about 30-32 pound basis weight has a substantially planar base portion having a rounded periphery, the base portion having an inside surface for receipt of beverage forming ingredient, and a resilient, substantially annular sidewall portion which extends upwardly and radially outwardly from the rounded periphery of the planar base portion, the annular sidewall portion having an inner surface for receipt of beverage forming ingredient and an outside surface for contacting the retainer and wherein the annular sidewall includes a plurality of ridges extending radially outwardly and valleys extending radially inwardly, the plurality of ridges and valleys cooperating when press-fit between the insert and retainer to enhance the flowability of liquid through the filter. The filter can preferably be made of cellulose fiber from chemically prepared wood from a wet crepe filter paper machine strength and flow rate.

Filter cups as described are prepared by means of apparatus which includes a device for assembling a plurality of sheets of filter paper into a composite web, and in a suitably humid environment for the web formation, a die for cutting discs of at least about 30 lb weight from the web and forming a central portion larger than the opening of bottom of the retainer and less than the inner diameter of the retainer and also a side wall having ridges and valleys about the central portion wherein each ridge and valley spacing are such as to aid supportive retention of the filter between the filter when press-fit therebetween and enhance the flowability of liquid through the filter.

The filters can be formed by die stretching the bottom portion in a manner to set the filters in the desired shape. A mold can include a body having a planar base portion having a rounded periphery, the base portion having an inside surface for receipt of the disc, an annular sidewall portion which extends upwardly and radially outwardly from the rounded periphery of the planar base portion and includes a plurality of radially outwardly extending ridges and radially inwardly extending valleys, where it is understood there are complementary male and female components.

### BRIEF DESCRIPTION OF THE DRAWINGS

FIG. 1 shows a perspective exploded view of the invention.

FIG. 2 shows a top view of the invention with hidden lines.

FIG. 3 shows a side sectional view through a top of the invention.

FIG. 4 shows a side sectional view through an insert of the invention.

FIG. 5 shows a side sectional view through a basket retainer of the invention.

FIG. 6 shows a top perspective view of the invention.

FIG. 7 shows a bottom perspective view of the invention.

FIG. 8 shows a side view of the invention.

FIG. 9 shows another bottom perspective view of the invention.

FIG. 10 shows a cross section of part of the filter of the invention as disposed in press-fit relation within the insert and retainer of the invention.

FIG. 11 shows a cross section through line A-A of FIG. 10.

FIG. 12 shows a cross section through line B-B of FIG. 10.

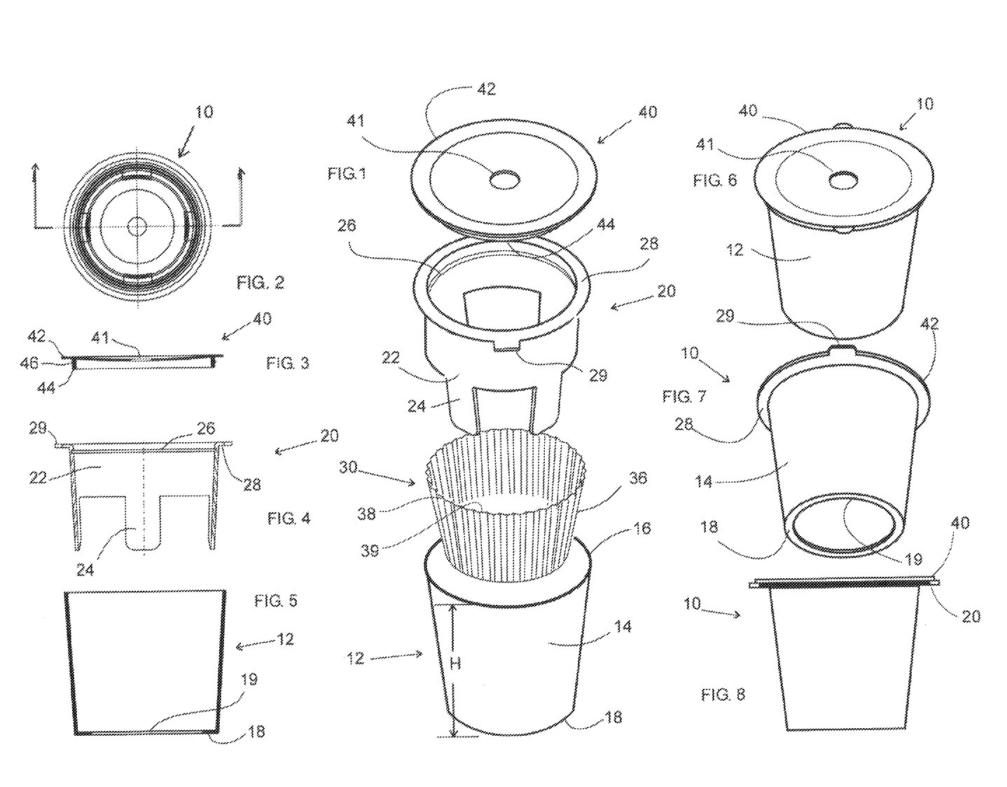

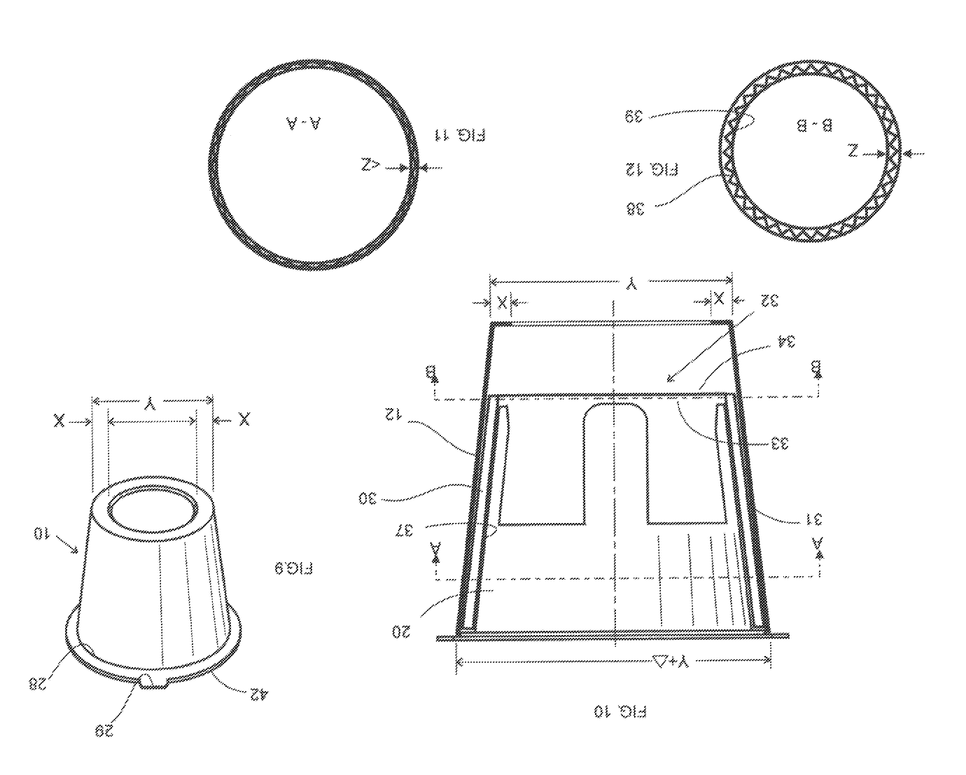

### DETAILED DESCRIPTION OF PREFERRED EMBODIMENTS

Referring now to the drawings, a single cup beverage ingredient filter basket is generally referred to by the numeral 10. The basket 10 includes a filter retainer 12 having an outer shell 14 with an upper end 16 having open top and a bottom 18 including a generally centrally located opening 19 therein. The shell 14 has a predetermined height H, which can be a length of about 1.5 inches. The bottom 18, the bottom 18 which is the form of an annular ring of a radial length X. The opening 19 is preferably large enough to permit insertion of one's finger therethrough. The diameter of the bottom 18 is a predetermined diameter Y which can preferably be about less than about 1.5 inch for the case of a K-cup alternative. The upper end 16 is predetermined diameter Y+Δ which is greater than Y. In this way, the outer shell is tapered.

An insert 20 is provided having an upper collar 22 of a less than the diameter of the upper end 16 of the retainer 12 to fit therein and has a lower extension 24 (which can include a plurality of fingers). The collar 22 and extension 24 are integral and form a taper in spaced relation to the shell 14. In the shown embodiment, the extension 24 form legs which leave gaps therebetween to enhance fluid flow therethrough.

In this way, a filter 30 can be generally cup shaped and disposed between the retainer 12 and the insert 20 such that the insert 20 press-fits the filter 30 within the retainer 12 to retain the filter 30 adjacent the retainer shell 14 as described herein. The filter 30 can preferably be at least about 30-32 pound basis weight and has a substantially planar base portion 32 having a generally rounded periphery. The base portion 32 has an inside surface 33 for receipt of beverage forming ingredient and an outside surface 34. The filter 30 has a substantially annular sidewall portion 36 which extends upwardly and radially outwardly from the rounded periphery of the planar base portion 32, the annular sidewall portion 36 having an inner surface 37 for receipt of beverage forming ingredient and an outer surface 31 for disposal against the shell 14. The base portion 32 can be less than the diameter of the Y diameter of the outer shell 14, for example, less than 1.5″ for example for K-cup alternative. The length of the sidewall 36 should be less than the height H of the outer shell 14, less than 1.5″ for example for K-cup alternative.

The annular sidewall 36 includes a plurality of ridges 38 extending radially outwardly and valleys 39 extending radially inwardly. The ridges 38 and valleys 39 are separated by a distance Z, for example less than about 2-3 mm for example when formed. The plurality of ridges 38 and valleys 39 cooperate when press-fit between the insert 20 and retainer 12 to enhance the flowability of liquid through the filter 30. As illustrated in FIGS. 10 and 11, the filter 30 when inserted between the insert 20 and retainer 12, is sufficiently compressed to enable self retention, but not so much as to inhibit fluid flow. The ridges 38 and valleys 39 are separated by a predetermined distance Z which is greater than zero and less than 0.5 cm and the insert 20 has an external diameter less than an internal diameter of the retainer 12 and wherein when the insert 12 is within the retainer 20, the insert 12 is diametrically separated from retainer 20 less than distance Z and greater than zero. The FIG. 12 illustrates the filter 30 in uncompressed area.

The filter 30 can preferably be made of cellulose fiber from chemically prepared wood from a wet crepe filter paper machine strength and flow rate. The filter 30 should be of a strength to withstand high pressure and heat from water injection from single cup coffee makers.

Further, the upper collar 22 can preferably include a peripheral lip 28 of a diameter at least that of the upper end 16 of the retainer 12 and preferably larger, to aid in removal of the insert 20. The peripheral lip 28 can include a tab 29 (or optionally a cut-off edge) to aid in separation from lip portion 42 of removable top 40. In this regard, the lip 28 can be slight smaller than the diameter of lip portion 42 while the tabs 29 extend laterally outward greater diametrically than the diameter of the lip portion 42. The lip 28 has a diameter of at least that of (and preferably greater than) the diameter of the upper end 16 of the retainer 12

Removable top 40 is provided has outer perimeter lip portion 42 with a diameter of at least that of (and preferably greater than) the diameter of the upper end 16 of the retainer 12 and has a lower collar portion 44 of a diameter less than the diameter of the upper collar 16 and configured to press-fit therein to secure it to the insert 20. The removable top 40 has an opening 41 therethrough which can preferably be centrally located and which is of a size to receive a water delivery conduit therethrough in a substantially seal tight manner to prevent water backing out the opening in top 40. In this regard a seal (not shown) may be provided about the conduit to abut about the opening 41 and conduit to prevent back flow.

Further, the lower collar portion 44 of the top 40 and the collar 22 of the insert 20 can be formed with a complementary detent mechanism to snap fit together and secure the two together for use and removal. By way of example, the collar portion 44 can include a radial protrusion 46 and the collar 22 can include an inner radial recess surface 26 to form the snap-fit relation. While tab 29 is shown, it is contemplated that an edge of either of the peripheral lip 28 of the insert 20 or the lip portion 42 of the top 40 can be recessed or extended to aid in separation of the two once connected.

The filter 30 can be formed by die stretching in a manner to set the filters in the desired shape. A mold can include a body having a planar base portion having a rounded periphery, the base portion having an inside surface for receipt of the disc, an annular sidewall portion which extends upwardly and radially outwardly from the rounded periphery of the planar base portion and includes a plurality of radially outwardly extending ridges and radially inwardly extending valleys, where it is understood there are complementary male and female components.

The preferred embodiment is intended for illustrating only and is not intended for limiting the claims. As such, modifications, derivations and improvements are to be covered by the appended claims hereto. It is to be understood that the invention is not to be limited to the exact details of operation or structure shown and described, as obvious modifications and equivalents will be apparent to one skilled in the art.

What is claimed is:

1. A single cup beverage ingredient containing filter basket, comprising:
a filter retainer having an upper end with open top and a bottom end including an opening therein;
an insert having an upper collar of a less than the diameter of the upper end of the retainer cup to fit therein and having a lower extension which when a filter is disposed between the retainer and the insert, the insert is dimensionally proportioned to press-fit the filter within the retainer to retain the filter between the insert and retainer yet not so tight between the insert and retainer as to substantially restrict fluid flow through sides of the filter and cause undue pressure on a bottom of the filter; and
a top having an outer perimeter lip portion of a diameter and configuration positionable to form a closure about the upper end of the retainer when disposed thereagainst.

2. The single cup beverage ingredient containing filter basket of claim 1, wherein said lower extension is disposed within a lower portion of the filter.

3. The single cup beverage ingredient containing filter basket of claim 1, wherein said top is removable and has a lower collar portion of a diameter less than the diameter of the upper collar of the insert and configured to press-fit and to removably secure to the same with said insert and wherein the top has an opening therethrough.

4. The single cup beverage ingredient containing filter basket of claim 1, wherein the insert includes a lip portion at least that of the diameter than the upper end of the retainer.

5. The single cup beverage ingredient containing filter basket of claim 1, wherein the lower extension includes a plurality of fingers.

6. The single cup beverage ingredient containing filter basket of claim 1, wherein the bottom of the filter retainer includes an annular collar about defining the bottom opening which aids to retain the filter.

7. The single cup beverage ingredient containing filter basket of claim 6, wherein the bottom opening is of a size to permit one's finger to be inserted therethrough.

8. The single cup beverage ingredient containing filter basket of claim 1, wherein the upper collar includes a peripheral lip of a diameter at least that of the upper end of the retainer to aid in removal of the insert.

9. The single cup beverage ingredient containing filter basket of claim 1, wherein the lower collar portion of the top and the collar of the insert are formed with a complementary detent mechanism to snap fit together and secure the two together for use and removal.

10. The single cup beverage ingredient containing filter basket of claim 1, wherein an edge of one of the peripheral lip of the insert and the lip portion of the top is one of recessed and extended to aid in separation of the two once connected.

11. The single cup beverage ingredient containing filter basket of claim 3, wherein one of the lip portion of the insert and the outer perimeter lip portion of the removable top has one of a tab and cutaway to aid in separation of the top and insert once connected.

12. A method of brewing a single cup of coffee comprises the steps of:
providing an electric coffee brewing machine; providing a single-use, reusable brew basket a filter retainer an upper end having open top and a bottom including an opening therein, an insert having an upper collar of a less than the diameter than the upper end of the retainer to fit therein and having a lower extension which when a filter is disposed within the retainer and the insert is disposed within the filter, the insert press-fits the filter within the retainer to retain the filter adjacent the retainer, and a removable top provided having an outer perimeter lip portion of at least that of the diameter of the upper end of the retainer and a lower collar portion of a diameter less than the diameter of the upper collar and configured to press-fit therein to secure the insert within the retainer, wherein the top has an opening therethrough;
disposing a single-use coffee filter between the retainer and the insert in a manner to cause the same to be press-fit therebetween;
putting coffee into the filter;
connecting the top onto the retainer such that the lower collar portion press-fits to the insert; and
inserting the disposable brew basket into the electric coffee brewing machine and brewing a single cup of coffee with the electric coffee brewing machine.

13. The method of claim 12, which further includes disassembling the basket, removing the filter with coffee therein and discarding the same while retaining the basket for reuse.

14. The method of claim 13, which further characterizes removing the filter by inserting one's finger through the bottom opening and pushing out the filter with coffee therein.

15. A filter for use in a reusable single cup beverage ingredient containing filter basket, which includes a paper based substrate having a substantially planar base portion, the base portion having an inside surface for receipt of beverage forming ingredient, and an annular sidewall portion which extends upwardly and radially outwardly from a periphery of the planar base portion, the annular sidewall portion having an inner surface for receipt of beverage forming ingredient and an outside surface for contacting the retainer and wherein the annular sidewall includes a plurality of ridges extending radially outwardly and valleys extending radially inwardly, the plurality of ridges and valleys cooperating when press-fit between an insert and a retainer of the basket enhance the flowability of liquid through the filter and wherein said filter is of a sufficient strength such that said sidewall when press-fit between a retaining cup and an insert is sufficient to aid in retention of said filter between the retainer and the insert and for holding a beverage forming ingredient therein when under subjected to high heat and pressure from a single cup brewer.

16. The filter of claim 15, wherein the reusable single cup beverage ingredient containing filter basket is characterized such that the retainer has an upper end with open top and a bottom end including an opening therein, the insert has an upper collar of a less than the diameter of the upper end of the retainer cup to fit therein and has a lower extension which when said filter is disposed between the retainer and the insert, the insert is dimensionally proportioned to press-fit the filter within the retainer to retain the filter between the insert and retainer yet not so tight between the insert and retainer as to substantially restrict fluid flow through sides of the filter and cause undue pressure on a bottom of the filter and a top having an outer perimeter lip portion of a diameter and configuration positionable to form a closure about the upper end of the retainer when disposed thereagainst.

17. The filter of claim 16, wherein the ridges and valleys are separated by a predetermined distance Z which is greater than zero and less than 0.5 cm and the insert has an external diameter less than an internal diameter of the retainer and wherein when the insert is within the retainer, the insert is diametrically separated from the retainer less than distance Z and greater than zero.

18. The filter of claim 15, wherein the ridges and valleys are separated by a predetermined distance Z which is greater than zero and less than 0.5 cm.

19. The filter of claim 17, wherein the insert has an external diameter less than an internal diameter of the retainer and wherein when the insert is within the retainer, the insert is diametrically separated from the retainer less than distance Z and greater than zero.
